(19) United States
(12) Patent Application Publication
(10) Pub. No.: US 2017/0165956 A1
(43) Pub. Date: Jun. 15, 2017

(54) PRINTING MECHANISM FOR A FLEXOGRAPHIC PRINTING PRESS AND METHOD FOR ITS OPERATION

(71) Applicant: CONPRINTA GmbH & Co. KG, Goettingen (DE)

(72) Inventor: Wolfgang BECKER, Northeim (DE)

(21) Appl. No.: 15/115,964

(22) PCT Filed: Jan. 16, 2015
(86) PCT No.: PCT/EP2015/050762

§ 371 Date: Aug. 2, 2016

(30) Foreign Application Priority Data
Feb. 5, 2014 (DE) 10 2014 101 433.2

(51) Int. Cl. B41F 33/00; B41F 5/24

(52) U.S. Cl. CPC B41F 33/0027; B41F 5/24

(57) ABSTRACT

A printing mechanism (10) has a plate cylinder (12) that supports a printing plate (18). A printing plate reference field (100) has a lowest reference field surface (101) lower than the printing plate (18) and a highest reference field surface (105) higher the printing plate in the printing motif region. A control unit can vary a distance between an impression cylinder (28) and the plate cylinder (12) for pressing a printing substrate against the printing plate (18) and can very a distance between an inking roller (20) and the printing plate (18). A first sensor (34) connected to the control unit determines a quality of a printed image of the printing plate reference field (100) on the printing substrate (30) and a second sensor (36) connected to the control unit determines a quality of a negative image of the printing plate reference field (100) on the inking roller (20).

### BACKGROUND

Field of the Invention

The invention relates to a printing mechanism for a flexographic printing press, comprising
a plate cylinder which supports a printing plate with a printing motif region and a printing plate reference field that has a plurality of reference field surfaces of different heights, wherein at least one lowest reference field surface (101) has a lower height than that of the printing plate (18) in the printing motif region, and at least one highest reference field surface (105) has a greater height than that of the printing plate in the printing motif region,
an impression cylinder, the distance from which to the plate cylinder can be varied, controlled by a control unit, for the purpose of pressing a printing substrate against the printing plate,
an inking roller, the distance from which to the printing plate can be varied, controlled by the control unit, the surface of which can be wetted with ink from an attached ink reservoir, for the purpose of inking said plate,
a first sensor connected to the control unit for determining a quality of a printed image of the printing plate reference field on the printing substrate.

Description of the Related Art

Such printing mechanisms for flexographic printing presses are described in the patent application DE 10 2013 010 763.6, which had not yet been published on the priority date of this patent application.

The technology of flexographic printing has been familiar to one skilled in the art for a long time. Flexographic printing presses typically comprise a plurality of serially arranged printing mechanisms through which a printing substrate passes sequentially. Each printing mechanism leaves a printed image on the printing substrate, whereby it is typical for different printing inks to be allocated to different printing mechanisms. In the case of one-color printing, it is also possible for the flexographic printing press to comprise only a single printing mechanism.

Key components of a printing mechanism for a flexographic printing press are the plate cylinder, the impression cylinder and the inking roller. The plate cylinder supports the printing plate, which is made of an elastic material. In the ‘sleeve’ design variant, the printing plate is fixed across its full surface to the plate cylinder. In the ‘belt’ design variant, the printing plate is fixed onto a flexible printing plate support designed as a continuous belt, the printing plate support being tensioned between the plate cylinder and a tensioning cylinder that is displaceable in a vertical direction with respect to the plate cylinder and is essentially oriented parallel to it. The present invention can be applied to both types of flexographic printing presses.

The impression cylinder, which is essentially oriented parallel to the plate cylinder, serves to press the printing substrate, typically a paper roll, against the printing plate such that ink can be transferred from the inked printing plate to the printing substrate. To this end, the impression cylinder and the plate cylinder are displaceable relative to one another so that the printing substrate and printing plate are pressed against one another within the nip between the impression cylinder and the plate cylinder at the positioning pressure pre-set by the control unit. There are also variants in which the impression cylinder is arranged in a fixed position within a machine frame and the plate cylinder is linearly displaceable, as well as variants in which the impression cylinder is displaceable toward the impression roller, relative to the machine frame. The present invention can be applied to both variants, although the former is generally preferred.

An inking roller, usually designed as an anilox roller, is provided to ink the printing plate. Its surface is wettable in a consistent manner with ink from an attached ink reservoir. To transfer the ink from the inking roller to the printing plate, the inking roller and printing plate are displaceable relative to one another, whereby here as well, a pre-set positioning pressure is to be generated by the control unit. The pressing together of the inking roller and printing plate therefore typically takes place in the region of the plate cylinder, which is oriented essentially parallel to the inking roller, such that the printing plate is pressed between the plate cylinder and inking roller at the actuated positioning pressure. In the case of belt technology, it is in principle also conceivable, although not normally preferred, to arrange the inking roller in the region of the tensioning cylinder and design both of these elements as displaceable with respect to one another. Other variants are known in which the inking roller is arranged in a fixed position within a machine frame and the plate cylinder is linearly displaceable toward the inking roller, relative to the machine frame; still other variants employ an inverse design in which the inking roller is linearly displaceable relative to the machine frame. The present invention can be applied to both variants, although the latter is usually preferred. The same applies accordingly to the pressing of the inking roller within the region of the tensioning cylinder.

Maintenance of the correct positioning pressure is essential for optimal printing results. If the positioning pressure of the inking roller is too high, the elastic printing plate is crushed too strongly during the inking process, such that even lower-lying regions of the printing plate are inked, which can result in traces of ink at undesired spots on the printing substrate. Conversely, if the positioning pressure of the inking roller is too low, the printing plate is not sufficiently inked, such that regions of the printing substrate that are supposed to be printed remain uninked. If the positioning pressure of the impression cylinder is too high, the elastic printing plate deforms too much during the printing process, such that fine contours are smeared. If the positioning pressure of the impression cylinder is too low, the printing substrate may be insufficiently inked.

In the aforementioned patent application, it is therefore suggested that the printing plate, preferably outside the actual printing area, be equipped with a printing plate reference field having a plurality of reference field surfaces of different heights. For example, the printing plate reference field can be designed in the shape of a stepped pyramid. The printing plate reference field is inked along with the rest of the printing plate, i.e., in particular together with its printing motif region, and leaves a characteristic printed image on the printing substrate. In particular, correctly setting the inking roller positioning pressure and impression cylinder positioning pressure results in a defined printed image of the printing plate reference field, which is composed only of reference surfaces of selected heights. A quality of the printed image of the printing plate reference field on the printing substrate can be monitored using an optical sensor, providing the printing press operator with valuable feedback regarding the correct setting of the positioning pressure. As used here, the term “quality” of the reference field printed image should not be understood in the limited sense of “commercial quality”. Rather, any desired characteristic of the reference field printed image that depends on the choice of positioning pressure can be detected by the sensor. In particular, the specific choice of the detected quality will depend on the specific design of the printing plate reference field. For example, an outline shape or the surface of a printed region, the presence of an edge or other characteristic of the printed image can be used as the quality to be detected by the sensor.

In the described printing process, it is disadvantageous that both aforementioned positioning pressures, which can be actuated independently of one another by the control unit, jointly contribute to the composition of the reference field printed image. If the quality detected by the sensor at the correct positioning pressure does not correspond to the expected values, the operator or known automatic systems cannot simply decide which of the configurable positioning pressure values has been wrongly set. Therefore, both positioning pressures must be varied until the reference field printed image corresponds to the set values. How rapidly the correct combination of positioning pressures can be identified depends largely on the individual experience of the operator or the algorithm of the automatic, iterative system, whereby due to the high running speed of modern printing presses, delays of even seconds can result in high losses of printing substrate and thereby high costs.

DE 10 2011 086 047 A1 discloses a printing mechanism for a flexographic printing press in which the inking roller is monitored across its entire width by an optical sensor in order to monitor the negative image of the printing motif region of the printing plate for its quality.

DE 10 2007 028 327 A1 discloses a flexographic printing press whose printing mechanisms print, in the marginal region of the printing substrate, a measurement strip representative of the actual printing motif. For this purpose, the respective printing plate has a measurement strip printing element, comprising, in itself and with the printing motif region of the printing plate, printing elements of the same height that are separated by non-printing elements arranged at a lower height. The quality of the printed measurement strips exhibits the same effects as the actual printing motif in the event of an incorrect adjustment of the positioning pressures.

DE 20 2012 000 246 U1 and DE 10 2008 025 114 A1 disclose generally the automatic setting of positioning pressures of a printing mechanism for a flexographic printing machine based on optical monitoring of the printed image.

DE 20 2006 020 066 U1 discloses a similar system, which however has colour-specific sensors for monitoring the printed image.

The problem that the present invention seeks to solve is to provide an improved printing mechanism for a flexographic printing press as well as a method for its operation that enable an optimal combination of positioning pressures to be automatically set.

### SUMMARY

This problem is solved, as explained herein, by a printing mechanism that has a second sensor connected to the control unit for detecting a quality of a negative image of the printing plate reference field on the inking roller.

A method according to the invention for actuating such a printing mechanism is characterized in that the quality of the printed image of the printing plate reference field is monitored on the printing substrate by the first sensor and the quality of the negative image of the printing plate reference field on the inking roller is monitored by the second sensor, wherein
if the quality detected by means of the first sensor deviates from a pre-set quality level, only a positioning pressure of the impression cylinder is varied until the pre-set quality level of the printed image of the printing plate reference field is achieved, and
If the quality detected by means of the second sensor deviates from a pre-set quality level, initially a positioning pressure of the inking roller is varied until the pre-set quality level of the negative image of the printing plate reference field is achieved, and then the positioning pressure of the impression cylinder is varied until the pre-set quality level of the printed image of the printing plate reference field is achieved.

Therefore, by means of the second sensor, the positioning pressure of the inking roller can be monitored separately from the positioning pressure of the impression cylinder. When the positioning pressure is correctly set, the negative image of the printing plate reference field shows only the reference field surfaces above a pre-set limit height; however, these are shown in full. If the positioning pressure of the inking roller is too high, reference field surfaces of a lower height will also be shown on the negative image. Conversely, if the positioning pressure of the inking roller is too low, not all intended reference field surfaces will be shown in the negative image on the inking roller. The negative image on the inking roller is created by ink from the ink layer on the surface of the inking roller being transferred to the printing plate reference field. Accordingly, the thickness of the ink layer on the surface of the inking roller changes. If the quality of the negative image detected by the second sensor does not correspond to the pre-set values, the positioning pressure of the inking roller can be varied independently, whereby the necessary direction of variation is directly evident from the negative image. After correctly setting the positioning pressure of the inking roller, any deviation of the quality of the printed image of the printing plate reference field on the printing substrate can only be caused by the setting of the positioning pressure on the impression cylinder. The latter can therefore be set independently as well, whereby, in this case as well, the necessary direction of variation is directly evident from the printed image.

The invention therefore makes it possible to independently set the positioning pressures according to straightforward rules which can easily be implemented to achieve automation of the [pressure] setting process through implementation in appropriate software, making this process independent of the personal experience of an operator. Additionally, by using suitably rapid sensors, the setting can be adjusted in keeping with the actual production speed of the printing press. In the case of visual inspection by an operator, the setting process can only take place at a significantly reduced speed as a result of the limited speed of cognition of even the most experienced operator. Conversely [in the machine according to the invention], the correct positioning pressure values are dependent on the production speed of the machine itself.

It is advantageous for the control unit to be configured such that upon starting up the printing press, a positioning pressure of the inking roller is initially varied until a pre-set quality level of the negative image of the printing plate reference field is achieved, and then a positioning pressure of the impression cylinder is varied until a pre-set quality level of the printed image of the printing plate reference field is achieved. This therefore represents a printing mechanism according to the invention with automated initial configuration of the positioning pressures.

Alternatively or additionally, however, results-oriented positioning pressure monitoring can also be implemented during running operation of the printing mechanism. For this purpose, it is provided that the control unit is configured to monitor, by means of the first sensor, the quality of the printed image of the printing plate reference field on the printing substrate and to monitor, by means of the second sensor, the quality of the negative image of the printing plate reference field on the inking roller, and that
if only the quality detected by means of the first sensor deviates from a pre-set quality level, only a positioning pressure of the impression cylinder be varied until the pre-set quality level of the printed image of the printing plate reference field is achieved, but that
if the quality detected by means of the second sensor deviates from a pre-set quality level, first a positioning pressure of the inking roller be varied until the pre-set quality level of the negative image of the printing plate reference field is achieved, and then the positioning pressure of the impression cylinder be varied until the pre-set quality level of the printed image of the printing plate reference field is achieved.

In other words, the printed image and the negative image of the printing plate reference field are continuously monitored during the entire printing process. By comparing the qualities detected by the sensors, deviations from the pre-settings can be unambiguously traced back to an incorrect adjustment of one or the other, or both, positioning pressures. Accordingly the control unit can perform a precise readjustment. This can be done even with low quality deviations, such that rejects are avoided.

The sensors can be designed in different ways. It is conceivable to use imaging sensors. Due to the increased amount of data generated by such sensors, however, they are limited in respect of their speed; also, the evaluation of their data requires significant processing time, which cannot always be reconciled with the production speed of modern printing presses. As an alternative to imaging sensors, a line sensor arranged perpendicular to the transport direction of the printing substrate and parallel to the axis of rotation of the inking roller can be used. Even a sensor without spatial resolution, e.g., a simple photo diode, set for a characteristic feature of the printed or negative image, can be used as a sensor within the scope of the present invention.

In any case, it is advantageous for the first sensor to be synchronized with the transport movement of the printing substrate. This is advantageously achieved not by means of synchronization with the rotation movement of the plate cylinder, but rather by synchronization with the transport movement of the printing plate. In printing presses employing the ‘belt principle’, the rotation speed of the printing plate can differ from that of the plate cylinder (this problem does not occur in printing presses employing the ‘sleeve principle’), but is in any case also identical with the transport speed of the printing substrate and is easy to detect as a machine parameter.

Synchronization of the second sensor with the rotation movement of the inking roller is advantageous.

In the cases described above of a line detector or photo diode, synchronization is particularly important, even if cases without synchronization are conceivable. In the event of an imaging sensor, synchronization is also advantageous, for instance, to generate a still image that can be visually monitored by an operator.

Additional features and advantages of the invention are provided in the following special description and in the drawings.

### BRIEF DESCRIPTION OF THE DRAWINGS

FIG. 1 a highly schematic depiction of a flexographic printing press in cross-section.

FIG. 2 an exemplary depiction of a printing plate reference field.

FIG. 3 images of the printing plate reference field from FIG. 2 resulting from different positioning pressures, namely the printed image on the printing substrate (S1) and its negative image on the inking roller (S2).

### DETAILED DESCRIPTION

Identical reference numbers in the Figures refer to identical or analogous elements.

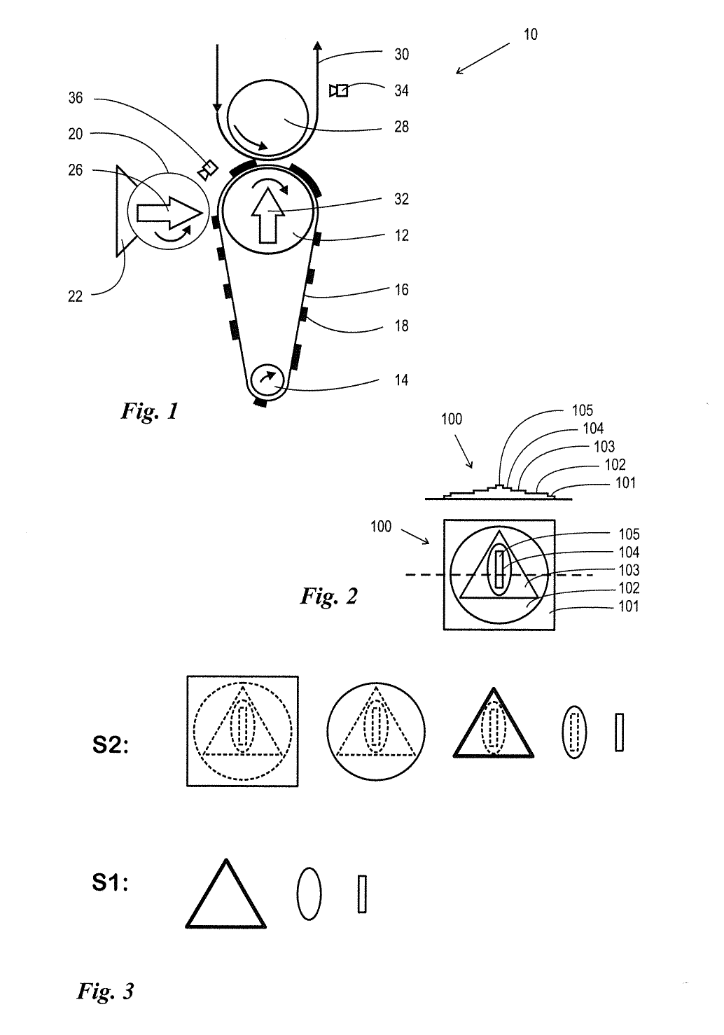

FIG. 1 is a highly schematic depiction of a cross-section through a printing mechanism 10 of a flexographic printing machine employing belt technology. A central element of the printing mechanism 10 is the plate cylinder 12. It is arranged essentially parallel to a tensioning cylinder 14 at a distance from it. A flexible printing plate support 16 is slung over both. The printing plate support 16 is designed as a continuous belt and bears the printing plate, which is a relief made of elastic material fixed on the printing plate support 16. The tensioning cylinder 14 is displaceable in the direction of its perpendicular distance to the plate cylinder 12 in order to tension the printing plate support 16.

To the left of the plate cylinder in FIG. 1, a rotating inking roller 20, which is connected to an ink reservoir 22, is arranged in essentially parallel orientation to the plate cylinder 12. When the inking roller 20 rotates, its surface is wetted with the ink. The thus inked inking roller 20 is displaced against the plate cylinder 12 with an adjustable positioning pressure 26 and thereby pressed against the printing plate 18 that runs between the plate cylinder 12 and inking roller 20. In the process, ink is transferred from the surface of the inking roller 20 to the printing plate 18.

Above the plate cylinder 12 in FIG. 1, an impression cylinder 28 is arranged in essentially parallel orientation to the plate cylinder 12. A roll-shaped printing substrate 30, e.g., a paper roll 30, is slung around it, whereby the printing substrate 30 passes through the nip between the plate cylinder 12 and the impression cylinder 28. To press the printing substrate against the printing plate 18 that runs around the plate cylinder 12, the plate cylinder 12 is displaceable against the impression cylinder 28 with an adjustable positioning pressure 32. The printing substrate 30 is thereby pressed against the inked printing plate 18, which results in ink being transferred from the printing plate 18 to the printing substrate 30, i.e., the actual printing process.

Within the scope of the invention, it is essential that the printing plate 18 have a printing plate reference field 100, an embodiment of which is schematically shown in FIG. 2 as an example. The printing plate reference field 100 has a plurality of surfaces 101-105 of various heights, which are preferably connected to one another. With regard to the shown embodiment, the reference field surfaces 101-105 have different shapes in order to better differentiate them in a top-down view. In the example shown, the reference field surface 101 has the lowest height and is in the shape of a square. The reference field surface 102 has the second-lowest height and is shaped as a circle inscribed within the square. The next-highest reference field surface 103 is shaped as a triangle inscribed within the circle. The second-highest reference field surface 104 has the shape of an oval inscribed within the triangle. The reference field surface 105, with the greatest height, has the shape of a rectangle inscribed within the oval. The heights of the reference field surfaces 101-105 are chosen such that at least the lowest reference field surface 101 has a lower height than the printing plate 18 in the region of the actual printing motif and that at least the highest reference field surface has a greater height than the printing plate in the region of the actual printing motif. During the printing process described above, the reference field 100 as well as the printing motif region of the printing plate 18 are inked by the inking roller and leave a printed image on the printing substrate 30.

As shown in FIG. 1, a first sensor 34 is arranged on the printing substrate 30, the signal from which sensor is synchronized with the transport speed of the printing substrate 30, the sensor being set to detect the printed image of the printing plate reference field on the printing substrate 30. Furthermore, a second sensor 36 is arranged on the surface of the inking roller 20, the signal from which sensor is preferably synchronized with the rotation movement of the inking roller 20, the sensor being set to detect the negative image which is left by the printing plate reference field 100, when rolling past the inking roller 20, in the ink film on the latter's surface.

FIG. 3 is a schematic depiction of possible images to be detected by the first sensor 34 (line S1) and the second sensor 36 (line S2). In reference to FIG. 3, a possible, automated process for adjusting the positioning pressures of the inking roller and impression cylinder 28 is described. For the purposes of simplicity, it is assumed in this explanation that the sensors 34 and 36 are imaging sensors and an evaluation of image data is performed within the scope of actuation. One skilled in the art will recognize, however, that line sensors or sensors without spatial resolution, such as simple photo diodes, can also be used to detect a pre-set quality of the images.

Line S2 in FIG. 3 shows different shapes of the negative images that can be left by the printing plate reference field 100 in the ink film on the surface of the inking roller 20, as a direct function of the positioning pressure 26. In FIG. 3, the positioning pressure decreases from left to right. At high positioning pressure, the entire printing plate reference field 100, up to and including its lowest reference field 101, is dipped into the ink film such that the outer outline of the negative image is square-shaped—which corresponds to the shape of the reference field surface 101. The outlines of the remaining reference field surfaces are shown as dotted in line 2 of FIG. 3 since, depending on the thickness and viscosity of the ink film as well as the quality of image detection, they can remain detectable by the second sensor 36. With a slightly reduced positioning pressure 26 of the inking roller 20, the printing plate reference field 100 is only dipped up to and including its circular surface 102 and accordingly leaves a negative image with a circular outline. At a still further reduced positioning pressure 26 of the inking roller 20, the printing plate reference field 100 is only dipped into the ink film up to and including its triangular reference field surface 103 and leaves a negative image with a triangular outline. The situation is analogous at further reduced positioning pressure 26, whereby negative images with oval or rectangular outlines are produced, and are detected by the second sensor 36. For the purpose of the exemplary example being explained, it is assumed that the positioning pressure of the inking roller 20 required to produce an optimal printed image of the actual printing motif is that pressure at which the printing plate reference field is dipped into the ink film up to and including its triangular reference field surface 103. The corresponding negative image is therefore shown in bold in line S2 of FIG. 3. This adjustment value of the positioning pressure 25 can easily be automatically identified and applied by a control unit through evaluation of the sensor signal from the second sensor 36. To do so, the control unit varies the positioning pressure 26, especially by horizontally displacing the inking roller 20, according to pre-determined rules, until the negative image shown in bold in line 2 of FIG. 3 is produced.

In a next step, the optimal positioning pressure 32 of the impression cylinder 28 can then be sought and adjusted, in particular through vertical displacement of the plate cylinder 12. The optimal positioning pressure 32 is given when precisely the inked regions of the printing plate 18 also leave a printed image on the printing substrate 30. Higher positioning pressure results in excessive deformation of the elastic printing plate relief; lower positioning pressure results in incomplete ink transfer onto the printing substrate. The latter would be the case in the example being explained if the inked reference field surface 103 did not leave a printed image on the printing substrate 30, but rather only one or both of the higher reference field surfaces 104, 105 were to do so. These possibilities are shown in line 1 of FIG. 3, whereby this depiction is a schematic reproduction of the printed image detected by means of the first sensor 34. The printed image that belongs to the “correct” positioning pressure 32 is shown in bold in line S1 of FIG. 3. Automated variation of the positioning pressure 32 of the impression cylinder 28 until this printed image results can be easily implemented by one skilled in the art by referring to the technical teaching explained here.

However, one skilled in the art will realize that the same printed image would also be produced at an excessively high positioning pressure 32, since in that case one or both of the lower-lying reference field surfaces 101, 102 would be pressed against the printing substrate 30; yet without inking of these surfaces 101, 102, no ink transfer would be possible. For implementation of an automated positioning pressure adjustment functionality it is therefore expedient first to set a positioning pressure 32 that is too low, that will only result in printing of a reference field surface 104, 105 that is higher than the lowest inked reference field surface 103, and then to increase the positioning pressure 32 until the printed image on the printing substrate 30 corresponds to the lowest inked reference field surface 103. In the example explained above, this would mean that the positioning pressure 32 is initially set such that a printed image with a rectangular or oval outline is shown. Afterwards, the positioning pressure 32 is increased sufficiently until a printed image with a triangular outline is produced.

Of course, other strategies are also conceivable with regard to implementing automated positioning pressure adjustment. For example, a positioning pressure 26 of the inking roller 20 could intentionally be first set too high, in order to find the optimum positioning pressure 32 of the impression cylinder 28.

Of course, the embodiments discussed in the special description and shown in the figures are only illustrative exemplary embodiments of the present invention. This disclosure gives one skilled in the art a broad spectrum of possible variations. In particular, the shape and complexity of the printing plate reference field 100 could be varied across a large scope. The specific sensor technology chosen for the first and second sensor 34, 36 is also only limited in terms of optical sensitivity; however, it is in no way limited with regard to a certain resolution capacity. Furthermore, the specific manner of producing the positioning pressures, in particular the choice of the element that is displaceable relative to the machine frame, is not relevant to the present invention. Ultimately one skilled in the art can also rely on a large amount of corresponding knowledge from the field of control technology with regard to the specific choice of optimization strategies for adjustment of the positioning pressures 26, 32.

### LIST OF REFERENCE NUMBERS

10 Printing mechanism
12 Plate cylinder
14 Tensioning cylinder
16 Printing plate support
18 Printing plate
20 Inking roller
22 Ink reservoir
26 Positioning pressure of 20, pressure arrow
28 Impression cylinder
30 Printing substrate
32 Positioning pressure of 28, pressure arrow
34 First sensor
36 Second sensor
100 Printing plate reference field
101 Reference field surface of 100
103 Reference field surface of 100
104 Reference field surface of 100
105 Reference field surface of 100

1. A printing mechanism (10) for a flexographic printing press, comprising
a plate cylinder (12) which supports a printing plate (18) with a printing motif region and a printing plate reference field (100) having a plurality of reference field surfaces (101-105) of different heights, wherein at least one lowest reference field surface (101) has a lower height than the printing plate (18) in the printing motif region, and at least one highest reference field surface (105) has a greater height than that of the printing plate in the printing motif region,
an impression cylinder (28), the distance from which to the plate cylinder (12) can be varied, controlled by a control unit, for the purpose of pressing a printing substrate against the printing plate (18),
an inking roller (20), the distance from which to the printing plate (18) can be varied, controlled by the control unit, the surface of which can be wetted with ink from an attached ink reservoir (22)
a first sensor (34) connected to the control unit for determining a quality of a printed image of the printing plate reference field (100) on the printing substrate (30) and
a second sensor (36) connected to the control unit for determining a quality of a negative image of the printing plate reference field (100) on the inking roller (20).

2. The printing mechanism (10) of claim 1,
wherein
the printing plate (18) is fixed on a flexible printing plate support (16) designed as a continuous belt that is tensioned between the plate cylinder (12) and a tensioning cylinder (14) that can be displaced perpendicular to the plate cylinder (12).

3. The printing mechanism (10) of claim 1,
wherein
upon startup of the printing mechanism, the control unit is set to first vary a positioning pressure (26) of the inking roller (20) until the negative image of the printing plate reference field (100) attains a pre-set quality level, then varies a positioning pressure (32) of the impression cylinder (28) until the printed image of the printing plate reference field (100) attains a pre-set quality level.

4. The printing mechanism (10) of claim 1,
wherein
the control unit is set to monitor, by means of the first sensor (34), the quality of the printed image of the printing plate reference field (100) on the printing substrate (30) and, by means of the second sensor (36), to monitor the quality of the negative image of the printing plate reference field (100) on the inking roller (20), and
if only the quality detected by means of the first sensor (34) deviates from a pre-set quality level, to vary only a positioning pressure (32) of the impression cylinder (28) until the pre-set quality level of the printed image of the printing plate reference field (100) is attained, but
if the quality detected by means of the second sensor (36) deviates from a pre-set quality level, to vary first a positioning pressure (26) of the inking roller (20) until the pre-set quality level of the negative image of the printing plate reference field (100) is attained, and then to vary the positioning pressure of the impression cylinder until the pre-set quality level of the printed image of the printing plate reference field (100) is achieved

5. The printing mechanism (10) of claim 1,
wherein
the first sensor (34) is synchronized with a transport movement of the printing substrate (30).

6. The printing mechanism (10) of claim 5,
wherein
the first sensor (34) is synchronized with a transport movement of the printing plate (18).

7. The printing mechanism (10) of claim 1,
wherein
the second sensor (36) is synchronized with a rotational movement of the inking roller (20).

8. A method for actuating the printing mechanism (10) of claim 1,
comprising
monitoring the quality of the printed image of the printing plate reference field (100) on the printing substrate (30) by the first sensor (34) and monitoring the quality of the negative image of the printing plate reference field (100) on the inking roller (20) by the second sensor (36), whereby
if only the quality detected by means of the first sensor (34) deviates from a pre-set quality level, only a positioning pressure (32) of the impression cylinder (28) is varied until the pre-set quality level of the printed image of the printing plate reference field (100) is attained, and
if the quality detected by means of the second sensor (36) deviates from a pre-set quality level, first a positioning pressure (26) of the inking roller (20) is varied until the pre-set quality level of the negative image of the printing plate reference field (100) is attained, and then the positioning pressure (32) of the impression cylinder (28) is varied until the pre-set quality level of the printed image of the printing plate reference field (100) is attained.
